(19) United States
(12) Patent Application Publication
(10) Pub. No.: US 2014/0207532 A1
(43) Pub. Date: Jul. 24, 2014

(54) Systems and Methods for Determining A Level of Expertise

(71) Applicant: Ashish V. Thapliyal, Santa Barbara, CA (US)

(72) Inventor: Ashish V. Thapliyal, Santa Barbara, CA (US)

(21) Appl. No.: 13/746,468

(22) Filed: Jan. 22, 2013

(51) Int. Cl. G06Q 10/06

(52) U.S. Cl. CPC G06Q 10/06398
USPC 705/7.42

(57) ABSTRACT

Systems and method for determining level of expertise are described. In some aspects, set of queries are stored. Each query is associated with subject and operator who attempts to solve query. Subject is one of plural subjects. Operator is one of plural operators. For each operator/subject combination where operator attempted to solve query associated with subject, non-normalized level of expertise of the operator for the subject is determined. For first subject from plural subjects, difficulty level for subject is determined. For first operator who has solved queries associated with first subject, normalized level of expertise of first operator for first subject is determined. Normalized level of expertise of first operator for first subject is stored.

### FIELD OF THE INVENTION

The subject technology relates generally to technology for evaluating abilities of humans. More specifically, the subject technology relates to determining a subject of a query and determining a level of expertise of an operator in responding to queries of the subject.

### BACKGROUND OF THE INVENTION

Oftentimes, people telephone or use online services (e.g., online video conferencing or text messaging services) to have their questions answered or to receive assistance. For example, a customer who purchased a product may telephone a call center to troubleshoot the product or to receive assistance in setting up or using the product. The customer may be routed to an operator based on the availability of the operator. However, various operators in the call center may have different skills useful in answering different types of queries from customers. In other words, the various operators may be skilled in various subjects.

### SUMMARY OF THE INVENTION

In some aspects, a computer-implemented method for determining a level of expertise is provided. The method includes storing, in a data repository, a set of queries, each query in the set of queries being associated with a subject and an operator who attempts to solve the query, the subject being one of a plurality of subjects, and the operator being one of a plurality of operators. The method includes determining, at one or more computing devices, for each operator/subject combination where the operator attempted to solve at least one query associated with the subject, a non-normalized level of expertise of the operator for the subject, the non-normalized level of expertise being based on a number of queries associated with the subject solved by the operator and an amount of time the operator spent on at least one query associated with the subject solved by the operator. The method includes determining, at the one or more computing devices, for a first subject from the plurality of subjects, a difficulty level for the subject, the difficulty level being based on an average of non-normalized levels of expertise of operators who have solved one or more queries associated with the first subject. The method includes determining, at the one or more computing devices, for a first operator who has solved the one or more queries associated with the first subject, a normalized level of expertise of the first operator for the first subject, the normalized level of expertise being based on the difficulty level for the subject and a non-normalized level of expertise of the first operator for the first subject. The method includes storing, in a memory, the normalized level of expertise of the first operator for the first subject.

In some aspects, a non-transitory computer-readable medium for determining a level of expertise is provided. The computer-readable medium includes instructions. The instructions include code for storing a set of queries, each query in the set of queries being associated with a subject and an operator who attempts to solve the query, the subject being one of a plurality of subjects, and the operator being one of a plurality of operators. The instructions include code for determining, for each operator/subject combination where the operator attempted to solve at least one query associated with the subject, a non-normalized level of expertise of the operator for the subject, the non-normalized level of expertise being based on a number of queries associated with the subject solved by the operator and an amount of time the operator spent on at least one query associated with the subject solved by the operator. The instructions include code for determining, for a first subject from the plurality of subjects, a difficulty level for the subject, the difficulty level being based on an average of non-normalized levels of expertise of operators who have solved one or more queries associated with the first subject. The instructions include code for determining, for a first operator who has solved the one or more queries associated with the first subject, a normalized level of expertise of the first operator for the first subject, the normalized level of expertise being based on the difficulty level for the subject and a non-normalized level of expertise of the first operator for the first subject. The instructions include code for storing the normalized level of expertise of the first operator for the first subject.

In some aspects, a system for determining a level of expertise is provided. The system includes processing hardware and a memory. The memory includes instructions. The instructions include code for storing a set of queries, each query in the set of queries being associated with a subject and an operator who attempts to solve the query, the subject being one of a plurality of subjects, and the operator being one of a plurality of operators. The instructions include code for determining, for each operator/subject combination where the operator attempted to solve at least one query associated with the subject, a non-normalized level of expertise of the operator for the subject, the non-normalized level of expertise being based on a number of queries associated with the subject solved by the operator and an amount of time the operator spent on at least one query associated with the subject solved by the operator. The instructions include code for determining, for a first subject from the plurality of subjects, a difficulty level for the subject, the difficulty level being based on an average of non-normalized levels of expertise of operators who have solved one or more queries associated with the first subject. The instructions include code for determining, for a first operator who has solved the one or more queries associated with the first subject, a normalized level of expertise of the first operator for the first subject, the normalized level of expertise being based on the difficulty level for the subject and a non-normalized level of expertise of the first operator for the first subject. The instructions include code for storing the normalized level of expertise of the first operator for the first subject.

In some aspects, a system for determining a level of expertise is provided. The system includes processing hardware and a memory. The memory includes instructions. The instructions include code for determining that levels of expertise for a first subject and for a second subject are correlated. The instructions include code for determining a level of expertise of a first operator for the first subject. The instructions include code for determining a level of expertise of a second operator for the first subject. The instructions include code for determining that a difference between the level of expertise of the first operator for the first subject and the level of expertise of the second operator for the first subject is within an expertise difference range. The instructions include code for determining a level of expertise of the first operator for the second subject. The instructions include code for predicting, in response to the difference between the level of expertise of the first operator for the first subject and the level of expertise of the second operator for the first subject being within the expertise difference range and levels of expertise for the first subject and for the second subject being correlated, a level of expertise of the second operator for the second subject based on the level of expertise of the first operator for the second subject.

### BRIEF DESCRIPTION OF THE DRAWINGS

The foregoing discussion will be understood more readily from the following detailed description of the invention, when taken in conjunction with the accompanying drawings, in which:

FIG. 1 illustrates an exemplary system for determining a level of expertise.

FIG. 2 illustrates an exemplary process for determining a level of expertise.

FIG. 3 illustrates an exemplary process for determining a level of expertise using collaborative filtering.

FIG. 4 illustrates an exemplary process for determining a level of expertise based on a stored set of queries.

FIG. 5 illustrates an exemplary process for determining a level of expertise based on a received set of queries.

FIG. 6 conceptually illustrates an exemplary electronic system with which some implementations of the subject technology are implemented.

### DETAILED DESCRIPTION

As set forth above, a customer who purchased a product may contact (e.g., using a telephone, a video calling service, or a text messaging service) a call center to troubleshoot the product or to receive assistance in setting up or using the product. However, various operators in the call center may have different skills useful in answering different types of queries from customers. For example, in a call center for a manufacturer of laptop computers, one operator may be skilled in operating system configuration while another operator may be skilled in hardware configuration. Determining an operator who is best suited to help a caller may be useful in routing a received call to an appropriate operator. In addition, operators in the call center could use the identifications of skilled operators to know who to ask for help if they have difficulty assisting a caller. Furthermore, operators who have the greatest skill in helping callers may be rewarded, for example, via a raise or a bonus. As the foregoing illustrates, a new approach for determining a level of expertise of an operator in a subject (e.g., operating system configuration, hardware configuration, etc.) may be desirable.

The subject technology provides techniques for determining a level of expertise of an operator in a subject. According to some aspects, one or more computers (e.g., a single computer, multiple computers connected via a network, a server, a server coupled with a data repository, etc.) receive a set of queries. The set of queries can correspond to calls received at a call center, text messages received at a text-message based help center, or video calls or electronic messages (e.g., email messages) received at a help center. The one or more computers determine that a subset of the set of queries is associated with a subject. The determination that a subset of the set of queries is associated with a subject can be made based on words in the queries. For example, a query about a computer mouse is likely to include the word “mouse.” The one or more computers provide the one or more queries from the subset to an operator. The one or more computers determine whether the operators solves each query in the one or more queries from the subset and an amount of time the operator spends on each query in the one or more queries from the subset. The determination whether the operator solves each query can be made based on feedback from the person who provided the query. The amount of time the operator spends on each query can be determined by measuring a length of a call, text messaging session, or video conferencing session between the person who provided the query and the operator. The one or more computers determine a level of expertise on the subject of the operator based on whether the operator solves each query in the one or more queries from the subset and the amount of time the operator spends on each query in the one or more queries from the subset. In some aspects, the level of expertise for an operator who solves a large number of queries in a small amount of time is greater than the level of expertise for an operator who solves a small number of queries in a large amount of time. The one or more computers store, in a memory (e.g., a local memory of the one or more computers or a remote data repository), the level of expertise on the subject for the operator.

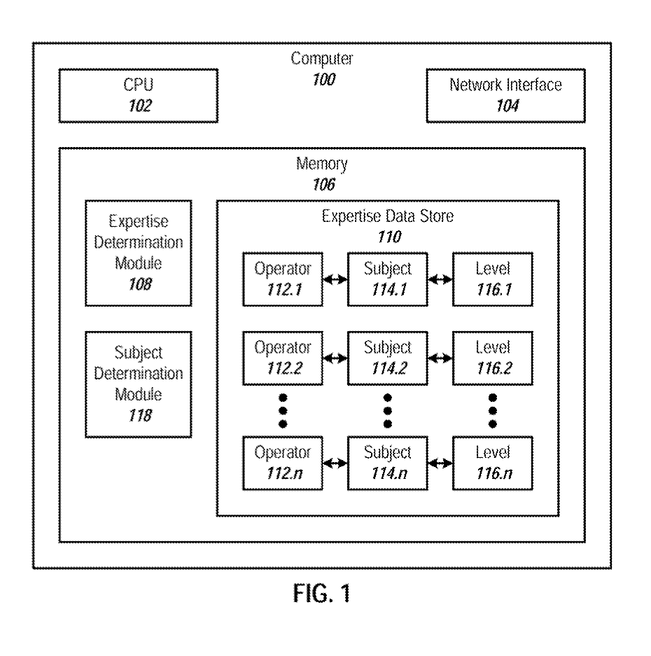

FIG. 1 illustrates an exemplary system for determining a level of expertise. The system of FIG. 1 is illustrated as including a single computer 100. However, according to some aspects, the components of the computer 100 of FIG. 1 may be implemented on multiple computers. Each of the multiple computers can include a portion of the components of the computer 100.

The computer 100 can include one or more of a server, a database with processing capabilities, a laptop computer, a desktop computer, a mobile phone, a personal digital assistant (PDA), a tablet computer, a netbook, a television with one or more processors embedded therein or coupled thereto, a computing device residing within a refrigerator, an automobile, an aircraft, etc., a physical machine, or a virtual machine.

As shown, the computer 100 includes a central processing unit (CPU) 102, a network interface 104, and a memory 106. The CPU 102 includes one or more processors. The CPU 102 is configured to execute computer instructions that are stored in a computer-readable medium, for example, the memory 106. In some aspects, the CPU 102 may be replaced or used in conjunction with other processing hardware. The network interface 104 is configured to allow the computer 100 to transmit and receive data in a network, e.g., the Internet, a cellular network, a wired network, or a wireless network. The network interface 104 may include one or more network interface cards (NICs). The memory 106 stores data or instructions. The memory 106 may be one or more of a cache unit, a storage unit, an internal memory unit, or an external memory unit. As illustrated, the memory 106 includes an expertise determination module 108, a subject determination module 118, and an expertise data store 110.

The subject determination module 118 is configured to determine a subject of a received query. The subject of a query may be determined based on key word(s) or statically improbable phrase(s) in the query. In some aspects, plural received queries can be clustered into different subjects based on common key word(s) or common statically improbable phrase(s) that appear in the query. For example, a call center for a travel service may receive queries including the key words “Europe” or “Asia” and cluster the queries into subjects based on which of these key words appears in the query.

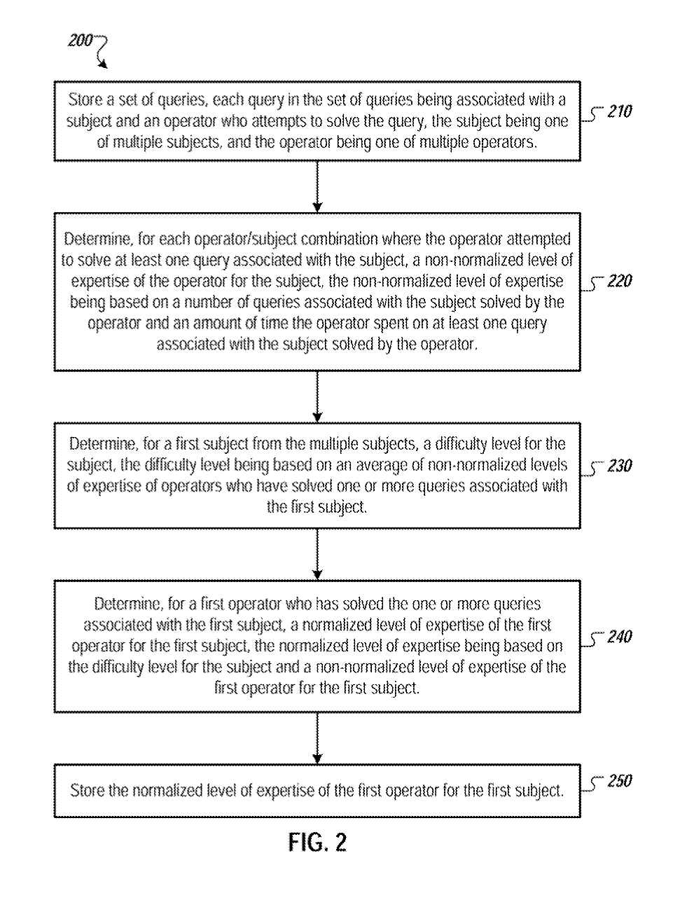

The expertise determination module 108 is configured to determine a level of expertise of an operator in a subject. Exemplary operations of the expertise determination module 108 are described in conjunction with FIGS. 2-5 below. Level(s) of expertise of operator(s) in subject(s) determined by the expertise determination module 108 are stored in the expertise data store 110.

The expertise data store 110 stores a set of operators 112.1-n. Each operator 112.k is associated with a subject 114.k and a level of expertise 116.k. The expertise data store 110 may be implemented using any known data structure for storing multiple entries, for example, an array, a table, a matrix, a hash table, a linked list, etc. According to some examples, an operator can have stored levels of expertise in a single subject or in multiple subjects. For example, in a call center that advises pet owners how to care for their pets, a first operator named “Joseph ABC” can have a level of expertise for the subject “cat” and for the subject “dog.” A second operator named “Amanda DEF” can have a level of expertise for the subject “cat” and for the subject “fish,” but not for the subject “dog.” A third operator named “Cindy GHI” can have a level of expertise for the subject “snake.” In some aspects, the subject 114.k can include a subject including multiple different queries, e.g., the subject “cat” can include multiple different queries related to cats. In some aspects, the subject 114.k can include a single query, for example, the query, “How does one install an online banking application on a smartphone?”

FIG. 2 illustrates an exemplary process 200 for determining a level of expertise.

The process 200 begins at step 210, where one or more computers (e.g., computer 100, via operation of the expertise determination module 108, another computer, or multiple computers) store a set of queries. The set of queries may be stored in data repository, in a local memory of the one or more computers, or in a remote memory. Each query in the set of queries is associated with a subject (e.g., how to install an operating system on a computer) and an operator who attempts to solve the query. The subject is one of multiple subjects. The operator is one of multiple operators (e.g., multiple operators employed at a call center).

In some aspects, storing the set of queries may include receiving an input query, determining a subject for the input query, and providing the input query to an available operator. The one or more computers determine whether the available operator solves the input query and an amount of time the available operator spends on the input query. The input query is stored, in a data repository, a local memory, or a remote memory, in association with the determined subject and the available operator. The subject for the input query can be determined based on one or more keywords in the input query or based on statistically improbable phrases in the input query.

To determine whether the available operator solves the first query, the one or more computers may receive first feedback, from a provider of the input query, regarding whether the available operator solves the input query. The one or more computers may receive second feedback, from the provider of the input query, regarding the quality of the solution to the input query provided by the available operator. The level of expertise of the available operator for the determined subject may be determined based on the first feedback or the second feedback, among other factors.

In step 220, the one or more computers determine, for each operator/subject combination where the operator attempted to solve at least one query associated with the subject, a non-normalized level of expertise of the operator for the subject. The non-normalized level of expertise is based on a number of queries associated with the subject solved by the operator and an amount of time the operator spent on at least one query associated with the subject solved by the operator. The operator's level of expertise for the subject may be calculated based on a percentage of queries about the subject that the operator solved, an amount of time that the operator took to reach the solution, and a satisfaction with the solution of the provider of the query.

In step 230, the one or more computers determine, for a first subject from the multiple subjects, a difficulty level for the subject. The difficult level for the subject is based on an average of non-normalized levels of expertise of operators who have solved one or more queries associated with the first subject. In one example, the difficulty level corresponds to the mean non-normalized expertise score, with a lower non-normalized expertise score and a lower difficulty level indicating less knowledge, by the operators, about the subject. For example, the subject “rocket science” may have low non-normalized expertise score among operators and a high difficulty level number, indicating that “rocket science” is a difficult subject, with which few operators are familiar. However, the subject “ramen noodles” may have a high non-normalized expertise score among operators and a low difficulty level number, indicating that “ramen noodles” is a simple subject, with which many operators are familiar. The one or more computers may also calculate a standard deviation of non-normalized expertise scores for the subject among the operators or a range of non-normalized expertise scores for the subject among the operators.

If difficulty levels for multiple subjects are computed, the difficulty levels may be used to compare the relative difficulty of subjects with one another. For example, as set forth above, a comparison of difficulty levels may be used to show that the subject “rocket science” is more difficult for operators than the subject “ramen noodles.”

In step 240, the one or more computing devices determine, for a first operator who has solved one or more queries associated with the first subject, a normalized level of expertise of the first operator for the first subject. The normalized level of expertise is based on the difficulty level for the subject and a non-normalized level of expertise of the first operator for the first subject (as determined in step 220). In some aspects, the normalized level of expertise is computed according to equation (1). However, other approaches for calculating the normalized level of expertise may also be used.

Xₙₒᵣₘ=(Xₙₒₙ₋ₙₒᵣₘ−A_{subject})σ_{subject} (1)

In equation (1) Xₙₒᵣₘ represents the normalized level of expertise of the first operator for the first subject. Xₙₒₙ₋ₙₒᵣₘ represents the non-normalized level of expertise of the first operator for the first subject. A_{subject} represents the average non-normalized level of expertise of operators for the first subject, where the operators have solved queries associated with the first subject. σ_{subject} represents the standard deviation of non-normalized levels of expertise of operators for the first subject, where the operators have solved queries associated with the first subject. According to some aspects, the average in equation (1) may be replaced with any representative sample of a distribution, for example, a median, a mode, a maximal likelihood sample, etc. According to some aspects, a deviation, a range, an interquartile range, or any other measure of statistical dispersion of non-normalized levels of expertise of operators for the first subject may be used in place of the standard deviation in equation (1).

Advantageously, the normalized level of expertise allows for quick comparison of one operator with another operator and with operators in general in answering queries about a subject. For example, an operator having a non-normalized level of expertise of “97” for a subject may not be very meaningful without additional information. However, an operator having a normalized level of expertise of “2.5” for the subject indicates that the operator is 2.5 standard deviations above the mean operator in solving queries associated with the subject.

In step 250, the one or more computers store, in a data repository, a local memory, or a remote memory, the normalized level of expertise of the first operator for the first subject.

In some aspects, the one or more computers may receive an additional query (e.g., from a caller to a call center). The one or more computers may determine that the additional query is associated with the first subject. The one or more computers may provide the additional query to the first operator based on the normalized level of expertise of the first operator for the subject being within a normalized level of expertise range (e.g., between a lower normalized level of expertise (e.g., 0.5) and an upper normalized level of expertise (e.g., 1.5) or exceeding a threshold normalized level of expertise (e.g., 1.5 or 2)) and the additional query being associated with the first subject.

In some aspects, any collaborative filtering approach or any recommender system approach may be used to predict a level of expertise of an operator in a subject, where the operator may not have answered any queries associated with the subject. Given a query, a recommender system can be used to recommend an operator who is available and who is most likely (e.g., based on his/her level of expertise) to solve the query satisfactorily. In some aspects, not all operators may be available at a given time (e.g., when a query from a caller is received), as some operators may be working with other callers or have time off. The recommender system problem can be solved with the additional constraint of choosing the best among available operators. According to some aspects, an actual or predicted level of expertise can be calculated for all of the available operators, and the query could be routed based on the actual or predicted levels of expertise. The query can also be routed based on other factors, for example, to avoid overburdening a single “expert” operator with multiple calls while other operators are handling much fewer calls or to allow a query to be routed to any operator having a level of expertise in the subject of the query above a certain threshold (e.g., greater than one standard deviation above a mean level of expertise).

Collaborative filtering involves predicting ratings (e.g., predicted Netflix® movie ratings) of products (e.g., Netflix® movies) by users (e.g., Netflix® users) based on ratings of other products (e.g., other Netflix® movies) by the users and correlations of product ratings (e.g., Netflix® movie ratings) among different users. The problem of determining a level of expertise of an operator in a subject can be mapped to the collaborative filtering problem. According to a first mapping the subject of the query corresponds to the user in the collaborative filtering problem (e.g., Netflix® user); the operator corresponds to the product in the collaborative filtering problem (e.g., Netflix® movie); and the level of expertise of the operator in the subject corresponds to the rating in the collaborative filtering problem (e.g., predicted or actual Netflix® movie rating for the movie by the user). According to a second mapping, the operator corresponds to the user in the collaborative filtering problem (e.g., Netflix® user); the subject of the query corresponds to the product in the collaborative filtering problem (e.g., Netflix® movie); and the level of expertise of the operator in the subject corresponds to the rating in the collaborative filtering problem (e.g., predicted or actual Netflix® movie rating for the movie by the user).

According to some examples, the one or more computers may determine that normalized levels of expertise for the first subject (e.g., “desktop computers”) and for a second subject (e.g., “mobile phones”) are correlated. The one or more computers may determine that a difference between the normalized level of expertise of the first operator for the first subject and the normalized level of expertise of a second operator for the first subject is within an expertise difference range (e.g., below a threshold difference value, which may be, for example, 0.3, 0.5, or 0.7). The one or more computers may predict a normalized level of expertise of the first operator for the second subject based on a normalized level of expertise of the second operator for the second subject. These aspects may be useful for predicting a normalized level of expertise in a subject of an operator who has not answered questions about the subject. For example, if multiple operators who have normalized levels of expertise indicating an ability to answer queries about “desktop computers” also have normalized levels of expertise indicating an ability to answer queries about “mobile phones,” an additional operator who has an ability to answer queries about “desktop computers” but has not yet answered a query about “mobile phones” is likely to have an ability to answer queries about “mobile phones.”

In some aspects, the subject of a query corresponds to a class within an issue. The issue includes multiple classes. For example, the issue “animal” may include the classes “cat,” “dog,” and “snake.” The subject “mode of transportation” includes the classes “car,” “bicycle,” and “train.” For each issue, a mean difficulty level can be calculated for the classes in the issue. Either each class can have an equal weight, or the classes may be weighted by the number of queries in each class (so that more popular classes get a higher weight). For each class, a normalized difficulty level can be calculated within the issue, to demonstrate, for example, that the class “dog,” is less difficult than the average class in the issue “animal” by one standard deviation.

According to some aspects, a normalized level of expertise or a non-normalized level of expertise of an operator for a subject may be associated with a confidence level. The confidence level can correspond to a standard deviation (or any other measure of statistical dispersion) of normalized or non-normalized levels of expertise. Alternatively, the confidence level can correspond to a number of queries solved or attempted by the operator in the subject (e.g., two operators, each of whom solved or attempted five queries in a subject, will each have the same confidence level for their levels of expertise; however, an operator who solved or attempted one hundred queries in the subject will have a higher confidence level for his/her level of expertise than an operator who solved or attempted five queries in the subject). In another alternative, the confidence level corresponds to a fraction of available queries in the subject that have been solved or attempted by the operator.

In some examples, an operator who solved or attempted many (e.g., a hundred) queries in a subject, with a small standard deviation in performance would have a level of expertise associated with a high confidence level. However, an operator who solved or attempted only one query in a subject, would have a calculated level of expertise with a low confidence level. Similarly, an operator who solved or attempted many (e.g., a hundred queries) in the subject, but has very high standard deviation in the scores, would have a level of expertise with a low confidence level.

The confidence level information could be used in routing queries. For example, if there are two operators with almost the same level of expertise in a given subject, one of whose level of expertise has a high confidence level and the other of whose level of expertise has a low confidence level, new queries may be routed either towards or away from the operator having the high confidence level, depending on whether a primary goal or purpose of the technique is to increase a confidence level in the level of expertise of the expert, or to reliably provide good service.

For example, the subject technology can be implemented in a call center with a two tiered system with a regular level customer support and a concierge level customer support, where the concierge level customer support is provided to frequent customers or customers who make premium purchases (e.g., passengers on an airline who travelled more than 100,000 miles with the airline during the last year). Queries from regular level users of the call center can be routed towards the lower confidence level operators, so that confidence in the level of expertise of the lower confidence level operators can be increased. Queries from concierge level users of the call center can be routed to operators having high confidence levels and high levels of expertise, so that concierge level customers have their queries resolved quickly and effectively. The one or more computing device can store the confidence level in association with the normalized or non-normalized level of expertise.

As set forth above, the steps 210-250 of the process 200 are carried out according to a certain order and in series. However, the steps 210-250 of the process 200 may be carried out in any order. In some aspects, two or more of the steps 210-250 can be carried out in parallel.

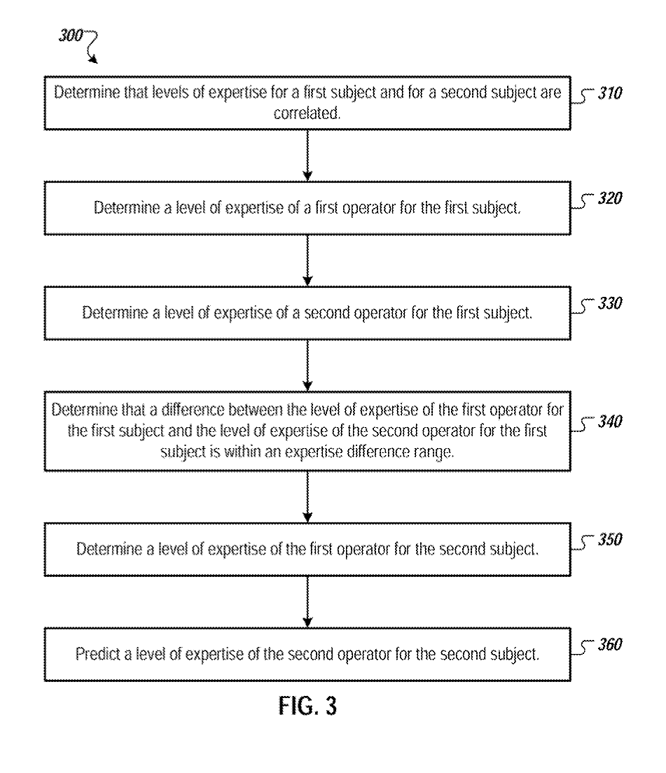

FIG. 3 illustrates an exemplary process 300 for determining a level of expertise using collaborative filtering.

The process 300 begins at step 310, where one or more computers (e.g., computer 100, via operation of the expertise determination module 108, another computer, or multiple computers) determine that levels of expertise (either a normalized or a non-normalized level of expertise) for a first subject and for a second subject are correlated. The one or more computers may make the determination by correlating levels of expertise among operators for the first subject with levels of expertise among operators for the second subject. For example, the one or more computers can determine that there is a correlation between expertise in the subject “France” and the subject “Italy,” based on stored levels of expertise of operators in the subjects “France” and “Italy.” Alternatively, a user may provide input indicating that levels of expertise in certain subjects should be correlated. For example, a user can manually provide an input indicating that levels of expertise in the subjects “France” and “Italy” should be correlated. In some examples, subjects corresponding to synonyms or words that are close in meaning may be determined to have correlated levels of expertise. For example, the subjects “digital music player” and “personal digital assistant” may have correlated levels of expertise, as a significant number of products function as both digital music players and personal digital assistants. Also, the queries, “How does one purchase a stock using a mobile phone?” and “How does one determine a value of one's stock portfolio using a tablet computer?” may have correlated levels of expertise, as both may involve the use of a stock brokerage application on a mobile computing device. Any other technique can be used to determine that two or more subjects have correlated levels of expertise. In some aspects, a Hamming distance between strings two subjects can be used to determine that the subjects have correlated levels of expertise. For example, the subjects “ABC Airlines” and “DEF Airlines” may have a correlated levels of expertise due to the relatively low Hamming distance (three characters are different out of twelve total characters) between the two strings representing the subjects.

In step 320, the one or more computers determine a level of expertise of a first operator for the first subject, for example, using all or a portion of the technique(s) described in conjunction with FIG. 2.

In step 330, the one or more computers determine a level of expertise of a second operator for the first subject, for example, using all or a portion of the technique(s) described in conjunction with FIG. 2. The second operator is different form the first operator.

In step 340, the one or more computers determine that a difference between the level of expertise of the first operator for the first subject and the level of expertise of the second operator for the first subject is within an expertise difference range. The expertise difference range may correspond to levels of expertise below a threshold value, for example, below 0.3, 0.5, or 0.7 for normalized levels of expertise.

In step 350, the one or more computers determine a level of expertise of the first operator for the second subject, for example, using all or a portion of the technique(s) described in conjunction with FIG. 2. In some aspects, the level of expertise of the second operator for the second subject may not be determined, for example, because the second operator has not solved any queries associated with the second subject.

In step 360, the one or more computers predict a level of expertise of the second operator for the second subject. According to some aspects, the level of expertise of the second operator for the second subject is predicted based on the level of expertise of the first operator for the first subject. For example, the one or more computers may predict that the second operator will have the same level of expertise in the second subject as the first operator. The prediction is in response to (i) the difference between the level of expertise of the first operator for the first subject and the level of expertise of the second operator for the first subject being within the expertise difference range and (ii) levels of expertise for the first subject and for the second subject being correlated. According to some examples, the level of expertise of the second operator for the second subject is predicted using collaborative filtering or recommender system techniques.

According to some aspects, an additional query may be received. The one or more computers may determine that the additional query is associated with the second subject. The one or more computers may provide the additional query to the second operator based on the predicted level of expertise of the second operator for the second subject being within a level of expertise range (e.g., between a minimum and a maximum level, or exceeding a minimum level) and the additional query being associated with the second subject. After step 360, the process 300 ends.

As set forth above, the steps 310-360 of the process 300 are carried out according to a certain order and in series. However, the steps 310-360 of the process 300 may be carried out in any order. In some aspects, two or more of the steps 310-360 can be carried out in parallel.

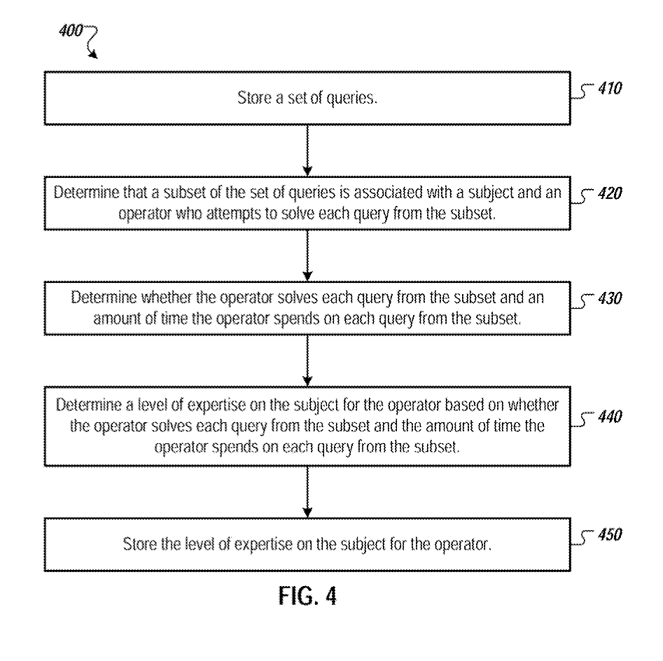

FIG. 4 illustrates an exemplary process 400 for determining a level of expertise (e.g., level 116.k) based on a stored set of queries.

The process 400 begins at step 410, where one or more computers (e.g., computer 100, via operation of the expertise determination module 108, another computer, or multiple computers) store a set of queries. The set of queries may be stored in a data store, for example, in the memory of the one or more computers or in an external data repository. Each query may be associated with an indication whether the query was solved, a time the operator spent on the query, or a satisfaction level of a provider of the query. Alternatively, whether the query was solved, the time the operator spent on the query, or the satisfaction level of the provider of the query may be determined by the one or more computers.

In some aspects, the set of queries stored in the data store can be constructed online and in real-time as the queries are received. When a query is received, the subject of the query may be determined and the query may be provided to a particular operator for providing a solution to the provider of the query and for determining whether the operator can solve the query and how long the particular operator will spend on the query.

In step 420, the one or more computers determine that a subset of the set of queries is associated with a subject and an operator who attempts to solve each query from the subset. Queries may be assigned to operators to solve, with each query being assigned to an operator. For example, a call center may assign an operator to handle a call. The determination that the subset of the set of queries is associated with a subject can be made based on keyword(s) in the queries. For example, a query about software is likely to have the words “software,” “program,” “application,” or “computer” in the query. In some aspects, the one or more computers determine one or more statistically improbable phrases in each query and determine a subject for the query based on the statistically improbable phrases in the query. In some aspects, the one or more computers determine that a first query in the set of queries is associated with the subject if the first query includes one or more keywords corresponding to the subject. For example, if a query received at a call center of a furniture store includes the keywords “kitchen table,” the query is likely related to a kitchen table.

In step 430, the one or more computers determine whether the operators solves each query from the subset and an amount of time the operator spends on each query from the subset. Whether the operator solves the query can be determined based on feedback from a person providing the query (e.g., a caller to the call center) or based on feedback from the operator. The amount of time can be determined by timing the call, conference, or messaging session between the person providing the query and the operator. In some aspects, whether the operator solves a particular query or the amount of time the operator spends on the particular query are stored in the data store in association with the particular query.

In step 440, the one or more computers determine a level of expertise (e.g., level 116.k) on the subject (e.g., subject 114.k) for the operator (e.g., operator 112.k) based on whether the operator solves each query from the subset and an amount of time the operator spends on each query from the subset.

In step 450, the one or more computers store the level of expertise on the subject for the operator. The level of expertise can be stored in a local memory of the one or more computers (e.g., in the expertise data store 110, which resides in the memory 106 of the computer 100) or in a data repository external to the one or more computers. After step 450, the process 400 end.

As set forth above, the steps 410-450 of the process 400 are carried out according to a certain order and in series. However, the steps 410-450 of the process 400 may be carried out in any order. In some aspects, two or more of the steps 410-450 can be carried out in parallel.

According to some aspects of the subject technology, queries stored in a data store are clustered into multiple subjects. An operator is associated with each query, and whether the operator solved the query and an amount of time spent by the operator on the query is determined. For a specific operator, a level of expertise is determined for a specific subject from among the multiple subjects based on whether the specific operator solved one or more queries in the specific subject and the amount of time spent. The level of expertise of the specific operator in the specific subject is stored. If the specific operator did not solve any queries having the specific subject, an indication that the level of expertise of the specific operator in the specific subject cannot be determined may be stored.

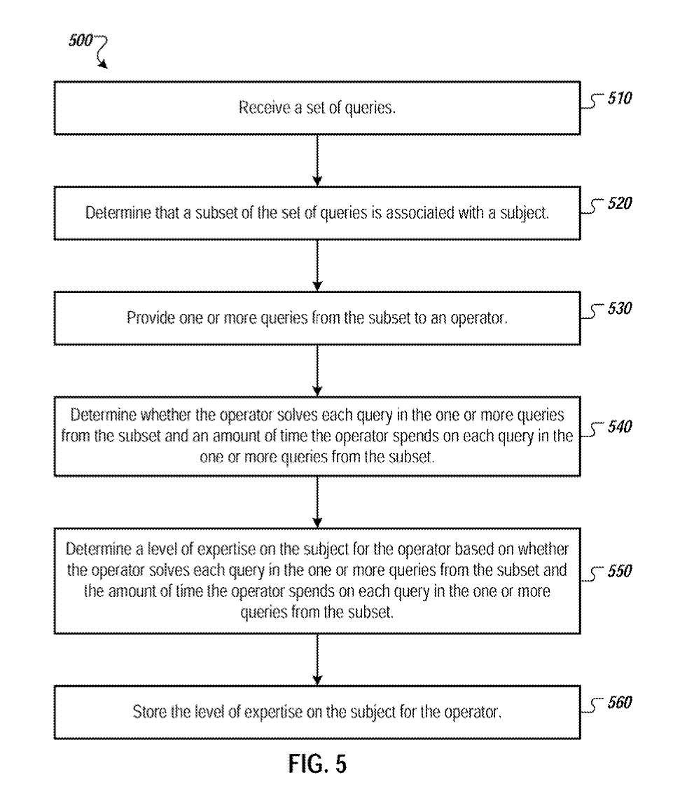

FIG. 5 illustrates an exemplary process 500 for determining a level of expertise (e.g., level 116.k) based on a received set of queries.

The process 500 begins at step 510, where one or more computers (e.g., computer 100, via operation of the expertise determination module 108, another computer, or multiple computers) receive a set of queries. The set of queries can correspond to calls to a call center, help center, or question answering service, or text messages, electronic messages (e.g., email), or video conference calls with a call center, help center, or question answering service.

In step 520, the one or more computers determine that a subset of the set of queries is associated with a subject. In some aspects, the one or more computers cluster the set of queries among a multiple subjects. The subject associated with the subset is one of the multiple subjects. For example, a question answering service for a provider of electronic devices can cluster queries among the subjects: “laptop computer,” “desktop computer,” “mobile phone,” “tablet computer,” and “other.” The clustering can be completed based on statistically improbable phrase(s) within the received queries.

In step 530, the one or more computers provide one or more queries from the subset to an operator. An operator can be provided with a query because the operator has a level of expertise within a level of expertise range for a subject of the query or simply because the operator is available and is not handling another call, conference, or messaging session.

In step 540, the one or more computers determine whether the operator solves each query in the one or more queries from the subset and an amount of time the operator spends on each query in the one or more queries from the subset.

In step 550, the one or more computers determine a level of expertise (e.g., level 116.k) on the subject (e.g., subject 114.k) for the operator (e.g., operator 112.k) based on whether the operator solves each query in the one or more queries from the subset and the amount of time the operator spends on each query in the one or more queries from the subset.

In some aspects, the one or more computers determine a difficulty level for at least one query in the one or more queries from the subset. The level of expertise on the subject of the operator can be determined based on the difficulty level. The difficulty level can be determined based on a number of other operators who attempted to solve the query or a query having similar keyword(s), statically improbable phrase(s), length (in terms of the number of words in the query or the amount of time the person providing the query spent explaining the query), or other characteristic(s).

In some aspects, the one or more computers determine a satisfaction level of a person providing at least one query in the one or more queries from the subset. The level of expertise on the subject for the operator can be determined based on the satisfaction level. The satisfaction level can be determined based on feedback from the person providing the query.

In step 560, the one or more computers store the level of expertise on the subject for the operator. The level of expertise can be used to reward (e.g., financially compensate) the experts who are the most helpful in responding to received queries. The level of expertise could be provided to the operators in the call center or question answering service to allow them to route difficult queries to appropriate expert(s).

In some aspects, the one or more computers receive an additional query and determine that the additional query is associated with the subject. The one or more computers provide the additional query to the operator based on the level of expertise on the subject for the operator being within a level of expertise range (e.g., the level of expertise either exceeds or falls below a threshold level of expertise) and the additional query being associated with the subject. In some examples, the one or more computers determine that the additional query has a difficulty level within a difficulty level range (e.g., the difficulty level either exceeds or falls below a threshold difficulty level or the difficulty level is between lower difficulty threshold level and an upper difficulty threshold level). The additional query is provided to the operator based on the additional query having a difficulty level within the difficulty level range. After step 560, the process 500 ends.

As set forth above, the steps 510-560 of the process 500 are carried out according to a certain order and in series. However, the steps 510-560 of the process 500 may be carried out in any order. In some aspects, two or more of the steps 510-560 can be carried out in parallel.

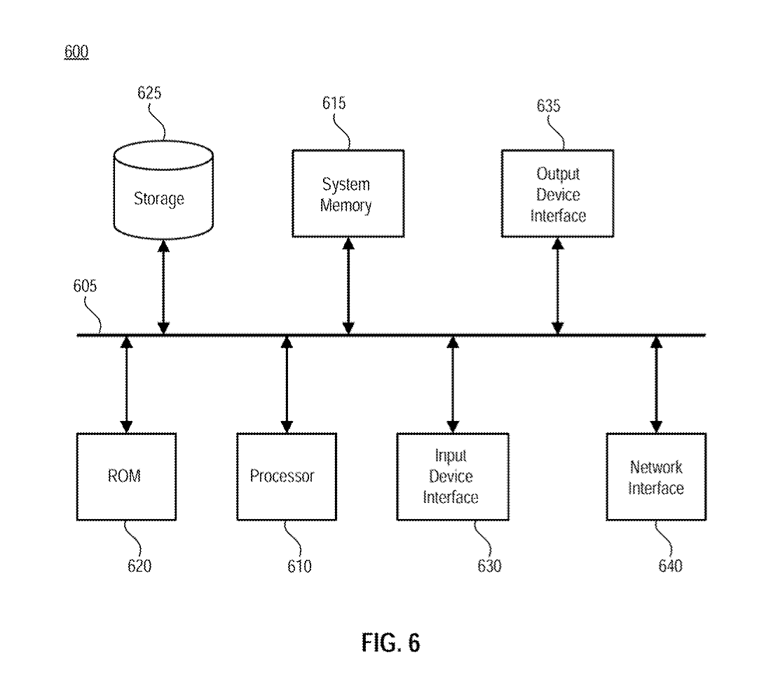

FIG. 6 conceptually illustrates an electronic system 600 with which some implementations of the subject technology are implemented. For example, the computer 100 may be implemented using the arrangement of the electronic system 600. The electronic system 600 can be a computer (e.g., a mobile phone, PDA), or any other sort of electronic device. Such an electronic system includes various types of computer readable media and interfaces for various other types of computer readable media. Electronic system 600 includes a bus 605, processing unit(s) 610, a system memory 615, a read-only memory 620, a permanent storage device 625, an input device interface 630, an output device interface 635, and a network interface 640.

The bus 605 collectively represents all system, peripheral, and chipset buses that communicatively connect the numerous internal devices of the electronic system 600. For instance, the bus 605 communicatively connects the processing unit(s) 610 with the read-only memory 620, the system memory 615, and the permanent storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some implementations of the subject technology use a mass-storage device (for example a magnetic or optical disk and its corresponding disk drive) as the permanent storage device 625.

Other implementations use a removable storage device (for example a floppy disk, flash drive, and its corresponding disk drive) as the permanent storage device 625. Like the permanent storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the processes of the subject technology are stored in the system memory 615, the permanent storage device 625, or the read-only memory 620. For example, the various memory units include instructions for determining a level of expertise in accordance with some implementations. From these various memory units, the processing unit(s) 610 retrieves instructions to execute and data to process in order to execute the processes of some implementations.

The bus 605 also connects to the input and output device interfaces 630 and 635. The input device interface 630 enables the user to communicate information and select commands to the electronic system. Input devices used with input device interface 630 include, for example, alphanumeric keyboards and pointing devices (also called “cursor control devices”). Output device interfaces 635 enables, for example, the display of images generated by the electronic system 600. Output devices used with output device interface 635 include, for example, printers and display devices, for example cathode ray tubes (CRT) or liquid crystal displays (LCD). Some implementations include devices for example a touch screen that functions as both input and output devices.

Finally, as shown in FIG. 6, bus 605 also couples electronic system 600 to a network (not shown) through a network interface 640. In this manner, the electronic system 600 can be a part of a network of computers (for example a local area network (“LAN”), a wide area network (“WAN”), or an Intranet, or a network of networks, for example the Internet. Any or all components of electronic system 600 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

1. A computer-implemented method for determining a level of expertise, the method comprising:
storing, in a data repository, a set of queries, each query in the set of queries being associated with a subject and an operator who attempts to solve the query, the subject being one of a plurality of subjects, and the operator being one of a plurality of operators;
determining, at one or more computing devices, for each operator/subject combination wherein the operator attempted to solve at least one query associated with the subject, a non-normalized level of expertise of the operator for the subject, the non-normalized level of expertise being based on a number of queries associated with the subject solved by the operator and an amount of time the operator spent on at least one query associated with the subject solved by the operator;
determining, at the one or more computing devices, for a first subject from the plurality of subjects, a difficulty level for the subject, the difficulty level being based on an average of non-normalized levels of expertise of operators who have solved one or more queries associated with the first subject;
determining, at the one or more computing devices, for a first operator who has solved the one or more queries associated with the first subject, a normalized level of expertise of the first operator for the first subject, the normalized level of expertise being based on the difficulty level for the subject and a non-normalized level of expertise of the first operator for the first subject; and
storing, in a memory, the normalized level of expertise of the first operator for the first subject.

2. The method of claim 1, further comprising:
determining that normalized levels of expertise for the first subject and for a second subject are correlated; and
predicting, via a collaborative filtering technique or a recommender system technique, a normalized level of expertise of the first operator for the second subject based on the normalized level of expertise of the first operator for the first subject.

3. The method of claim 1, further comprising:
receiving an additional query;
determining that the additional query is associated with the first subject; and
providing the additional query to the first operator based on the normalized level of expertise of the first operator for the first subject being within a normalized level of expertise range and the additional query being associated with the first subject.

4. The method of claim 1, wherein storing the set of queries comprises:
receiving an input query;
determining a subject for the input query;
providing the input query to an available operator;
determining whether the available operator solves the input query and an amount of time the available operator spends on the input query; and
storing the input query in the set of queries in association with the determined subject and the available operator.

5. The method of claim 4, wherein the subject for the input query is determined based on one or more keywords in the input query.

6. The method of claim 4, wherein the subject for the input query is determined based on statistically improbable phrases in the input query.

7. The method of claim 4, wherein determining whether the available operator solves the input query comprises:
receiving first feedback, from a provider of the input query, regarding whether the available operator solves the input query.

8. The method of claim 7, further comprising:
receiving second feedback, from the provider of the input query, regarding a quality of a solution to the input query provided by the available operator, wherein a non-normalized level of expertise of the available operator for the determined subject is determined based on the second feedback.

9. The method of claim 1, further comprising:
determining a confidence level for the non-normalized level of expertise of the first operator for the first subject.

10. The method of claim 1, further comprising:
determining a confidence level for the normalized level of expertise of the first operator for the first subject.

11. The method of claim 10, wherein the confidence level corresponds to a measure of statistical dispersion of levels of expertise.

12. The method of claim 10, wherein the confidence level corresponds to a number of queries of the first subject attempted by the first operator or a fraction of available queries of the first subject attempted by the first operator.

13. A non-transitory computer-readable medium for determining a level of expertise, the computer-readable medium comprising instructions which, when executed by one or more computers, cause the one or more computers to implement a method, the method comprising:
storing a set of queries, each query in the set of queries being associated with a subject and an operator who attempts to solve the query, the subject being one of a plurality of subjects, and the operator being one of a plurality of operators;
determining, for each operator/subject combination wherein the operator attempted to solve at least one query associated with the subject, a non-normalized level of expertise of the operator for the subject, the non-normalized level of expertise being based on a number of queries associated with the subject solved by the operator and an amount of time the operator spent on at least one query associated with the subject solved by the operator;
determining, for a first subject from the plurality of subjects, a difficulty level for the subject, the difficulty level being based on an average of non-normalized levels of expertise of operators who have solved one or more queries associated with the first subject;
determining, for a first operator who has solved the one or more queries associated with the first subject, a normalized level of expertise of the first operator for the first subject, the normalized level of expertise being based on the difficulty level for the subject and a non-normalized level of expertise of the first operator for the first subject; and
storing the normalized level of expertise of the first operator for the first subject.

14. The computer-readable medium of claim 13, the method further comprising:
determining that normalized levels of expertise for the first subject and for a second subject are correlated; and
predicting, via a collaborative filtering technique or a recommender system technique, a normalized level of expertise of the first operator for the second subject based on the normalized level of expertise of the first operator for the first subject.

15. The computer-readable medium of claim 13, the method further comprising:
receiving an additional query;
determining that the additional query is associated with the first subject; and
providing the additional query to the first operator based on the normalized level of expertise of the first operator for the first subject being within a normalized level of expertise range and the additional query being associated with the first subject.

16. The computer-readable medium of claim 13, wherein storing the set of queries comprises:
receiving an input query;
determining a subject for the input query;
providing the input query to an available operator;
determining whether the available operator solves the input query and an amount of time the available operator spends on the input query; and
storing the input query in the set of queries in association with the determined subject and the available operator.

17. The computer-readable medium of claim 16, wherein the subject for the input query is determined based on one or more keywords in the input query.

18. The computer-readable medium of claim 16, wherein the subject for the input query is determined based on statistically improbable phrases in the input query.

19. The computer-readable medium of claim 16, wherein determining whether the available operator solves the input query comprises:
receiving first feedback, from a provider of the input query, regarding whether the available operator solves the input query.

20. The computer-readable medium of claim 19, further comprising:
receiving second feedback, from the provider of the input query, regarding a quality of a solution to the input query provided by the available operator, wherein a non-normalized level of expertise of the available operator for the determined subject is determined based on the second feedback.

21. A system for determining a level of expertise, the system comprising:
processing hardware; and
a memory comprising instructions which, when executed by the processing hardware, cause the processing hardware to implement a method, the method comprising:
storing each query in the set of queries being associated with a subject and an operator who attempts to solve the query, the subject being one of a plurality of subjects, and the operator being one of a plurality of operators;
determining, for each operator/subject combination wherein the operator attempted to solve at least one query associated with the subject, a non-normalized level of expertise of the operator for the subject, the non-normalized level of expertise being based on a number of queries associated with the subject solved by the operator and an amount of time the operator spent on at least one query associated with the subject solved by the operator;
determining, for a first subject from the plurality of subjects, a difficulty level for the subject, the difficulty level being based on an average of non-normalized levels of expertise of operators who have solved one or more queries associated with the first subject;
determining, for a first operator who has solved the one or more queries associated with the first subject, a normalized level of expertise of the first operator for the first subject, the normalized level of expertise being based on the difficulty level for the subject and a non-normalized level of expertise of the first operator for the first subject; and
storing the normalized level of expertise of the first operator for the first subject.

22. A non-transitory computer-readable medium for determining a level of expertise, the computer-readable medium comprising instructions which, when executed by one or more computers, cause the one or more computers to implement a method, the method comprising:
storing a set of operators and a set of subjects, wherein a first operator in the set of operators has a first level of expertise for a first subject in the set of subjects, and wherein a level of expertise of a second operator in the set of operators for a second subject in the set of subjects is unknown; and
determining the level of expertise of the second operator for the second subject based on the first level of expertise of the first operator for the first subject using a technique for solving a collaborative filtering problem or a technique for solving a recommender system problem.

23. The computer-readable medium of claim 22, wherein the collaborative filtering problem comprises predicting a rating of a specific user for a specific product, wherein the specific user corresponds to a specific subject in the set of subjects, wherein the specific product corresponds to a specific operator in the set of operators, and wherein the rating corresponds to a level of expertise of the specific operator for the specific subject.

24. The computer-readable medium of claim 22, wherein the collaborative filtering problem comprises predicting a rating of a specific user for a specific product, wherein the specific user corresponds to a specific operator in the set of operators, wherein the specific product corresponds to a specific subject in the set of subjects, and wherein the rating corresponds to a level of expertise of the specific operator for the specific subject.

25. The computer-readable medium of claim 22, wherein the first subject comprises a single first query and the second subject comprises a single second query.

26. A non-transitory computer-readable medium for determining a level of expertise, the computer-readable medium comprising instructions which, when executed by one or more computers, cause the one or more computers to implement a method, the method comprising:
determining that levels of expertise for a first subject and for a second subject are correlated;
determining a level of expertise of a first operator for the first subject;
determining a level of expertise of a second operator for the first subject;
determining that a difference between the level of expertise of the first operator for the first subject and the level of expertise of the second operator for the first subject is within an expertise difference range;
determining a level of expertise of the first operator for the second subject;
predicting, in response to the difference between the level of expertise of the first operator for the first subject and the level of expertise of the second operator for the first subject being within the expertise difference range and levels of expertise for the first subject and for the second subject being correlated, a level of expertise of the second operator for the second subject based on the level of expertise of the first operator for the second subject.

27. The computer-readable medium of claim 26, wherein determining the level of expertise of a first operator for the first subject comprises:
storing a set of queries, each query in the set of queries being associated with a subject and an operator who attempts to solve the query, the subject being one of a plurality of subjects, and the operator being one of a plurality of operators;
determining for each operator/subject combination wherein the operator attempted to solve at least one query associated with the subject, a non-normalized level of expertise of the operator for the subject, the non-normalized level of expertise being based on a number of queries associated with the subject solved by the operator and an amount of time the operator spent on at least one query associated with the subject solved by the operator;
determining for the first subject from the plurality of subjects, a difficulty level for the subject, the difficulty level being based on an average of non-normalized levels of expertise of operators who have solved one or more queries associated with the first subject; and
determining for the first operator who has solved the one or more queries associated with the first subject, a level of expertise of the first operator for the first subject, the level of expertise being based on the difficulty level for the subject and a non-normalized level of expertise of the first operator for the first subject.

28. The computer-readable medium of claim 26, the method further comprising:
receiving an additional query;
determining that the additional query is associated with the second subject; and
providing the additional query to the second operator based on the predicted level of expertise of the second operator for the second subject being within a level of expertise range and the additional query being associated with the second subject.
